(19) United States
(12) Patent Application Publication
(10) Pub. No.: US 2014/0371957 A1
(43) Pub. Date: Dec. 18, 2014

(54) METHOD AND DEVICE FOR DIAGNOSIS OF A LOSS OF CONTROL OF AN AIRCRAFT

(71) Applicant: THALES, Neuilly-sur-Seine (FR)

(72) Inventors: Marc RIEDINGER, PLAISANCE DU TOUCH (FR); Yannick MERET, LA SALVETAT SAINT GILLES (FR); Julien LOPEZ, TOULOUSE (FR)

(21) Appl. No.: 14/303,430

(22) Filed: Jun. 12, 2014

(30) Foreign Application Priority Data
Jun. 14, 2013 (FR) 1301371

(51) Int. Cl. B64F 5/00

(52) U.S. Cl. CPC B64F 5/0045
USPC 701/3

(57) ABSTRACT

A method for diagnosis of a loss of control of an aircraft comprises the steps: loading raw data; loading parameters of the aircraft; computing a plurality of reference data comprising a preprocessing comprising for at least one reference datum a sub-step of computing a phase advance term; determining the characteristic thresholds indicative of loss of control; detecting at least one type of loss of control by comparing the reference data with characteristic thresholds; and, when at least one type of loss of control is detected: identifying the type of priority loss of control corresponding to the type of loss of control exhibiting the highest priority level, and communicating the type of priority loss of control to a crew.

### CROSS-REFERENCE TO RELATED APPLICATION

This application claims priority to foreign French patent application No. FR 1301371, filed on Jun. 14, 2013, the disclosure of which is incorporated by reference in its entirety.

### FIELD OF THE INVENTION

The invention relates to the field of aiding the piloting of an aircraft and more particularly to a method of diagnosis of a loss of control, and optionally of guidance so as to exit from most losses of control.

A loss of control may originate from an event outside the aircraft (for example weather) or intrinsic to the aircraft (fault) or when through unsuitable piloting the pilot causes the aeroplane to exit its nominal flight domain.

### BACKGROUND

The issue is addressed differently depending on whether the aircraft exhibits mechanical flight controls or electric flight controls.

In the case of aircraft with mechanical flight controls, losses of control must be avoided by the pilot. Through training, he is aware of the nominal flight domain of his aeroplane and is schooled in not entering situations that could cause losses of control. Accordingly he uses visual information about the exterior environment and sensor data displayed on a primary flight display. The major defects of this solution are essentially:
reliability of the pilot in situations of fatigue, tension, disorientation or even loss of awareness,
lack of training of pilots in respect of exceptional situations of loss of control,
reliability of the sensor information, in particular in respect of sensors of anemometric type, sensitive to the exterior conditions, in particular of icing.

For aeroplanes with mechanical flight controls the company Rockwell Collis offers the ABC (Autonomous Backup Control) function which makes it possible, through the pilot's pressing of a dedicated button, to automatically return the aeroplane to wings level whatever its initial attitude. This document does not perform any diagnosis of the type of loss of control and does not use any preprocessing of the data.

For this same market segment, document U.S. Pat. No. 8,195,346 from the company Garmin describes a protection function ESP (Electronic Stability Protection) the aim of which is to deter the pilot from causing his aeroplane to leave a certain flight domain by applying a force on the stick counter to its controls. This document does not perform any diagnosis of the type of loss of control and does not use any preprocessing of the data. It is moreover not suited to coping with pilot independent situations of loss of control.

Flight domain protections, dubbed envelope protection, exist in the case of aircraft with electric flight controls. These protections prevent the pilot (or the automatic pilot) from causing the aircraft to exit its nominal flight domain when the flight controls are intact (e.g.: protection against stalling, overspeed, large attitudes, etc.). The level of protection varies as a function of the aircraft manufacturers and aircraft types. But on account of the unpredictability of certain situations, these protections are not effective for all cases of loss of control or the flight controls may pass to a degraded mode (case of faults), so affording less envelope protection function.

Document U.S. Pat. No. 8,086,361 describes an alert system aiding the pilot to extricate himself from a situation of disorientation accompanied by excessive roll, by indicating to him through displays or sound alerts the direction of the command to be performed in order to return the aeroplane to wings level. This document addresses solely the case of a loss of control due to excessive roll, and does not therefore perform a diagnosis allowing the identification of other types of loss of control, and does not exhibit any preprocessing of the data arising from the sensors integrating a phase advance term.

### SUMMARY OF THE INVENTION

An aim of the invention is to alleviate the aforementioned drawbacks by offering a method making it possible to aid the pilot to be aware of the loss of control situation and to identify the type of loss of control with which he has to cope, and more particularly of the type of priority control that he has to deal with first.

According to one aspect of the invention, the subject of the present invention is a method for diagnosis of a loss of control of an aircraft comprising the steps consisting in:

loading raw data originating from onboard sensors,

loading parameters of the aircraft,

computing a plurality of reference data relating to the aerodynamic behaviour of the aircraft, each reference datum being obtained on the basis of at least one value of a loaded raw datum, comprising a preprocessing, the said preprocessing comprising for at least one reference datum a sub-step of computing a phase advance term determined on the basis of the temporal evolution of the said reference datum,

determining characteristic thresholds indicative of loss of control respectively associated with a set of parameters comprising at least one reference datum and one type of loss of control,

detecting at least one type of loss of control by comparing the reference data with characteristic thresholds, each type of loss of control having an associated priority level,

when at least one type of loss of control is detected:

identifying the type of priority loss of control corresponding to the type of loss of control exhibiting the highest priority level,

communicating the type of priority loss of control to a crew.

Advantageously the reference data comprise an angle of incidence, a speed relative to the surrounding air, a load factor, an angle of roll and an angle of pitch, a yaw rate and a vertical speed of the aircraft.

Advantageously the preprocessing comprises a sub-step consisting in, for each reference datum, filtering at least one raw datum or estimating the reference datum on the basis of at least one raw datum, and a sub-step consisting in, for at least one reference datum, formulating the reference datum on the basis of the reference datum computed in the filtering/estimation step on the one hand and of the phase advance term on the other hand.

Advantageously at least one characteristic threshold is determined on the basis of parameters of the aircraft and/or of exterior data and/or of the type of mission performed by the aircraft.

Advantageously the method furthermore comprises a step consisting in loading additional data originating from onboard computers which generate alarms prior to the step of detecting at least one type of loss of control.

Advantageously the communicating of the type of priority loss of control to the pilot is carried out on the display banner of the modes of the automatic pilot.

According to a variant the method according to the invention furthermore comprises a guidance phase to make it possible to exit from the loss of control comprising the steps consisting in:

determining a strategy for exiting from the priority loss of control comprising a list of exit guidance commands to be executed on controls of the aircraft,

identifying a main exit guidance command to be executed by priority on an axis of the aircraft,

communicating the main exit guidance command to the crew.

Advantageously the method according to the invention furthermore comprises a step consisting in communicating a set of exit guidance commands dependent on the exit strategy to the crew via a flight director.

Advantageously an exit strategy furthermore comprises a list of aircraft motorization and/or configuration control actions.

Advantageously the method according to the invention furthermore comprises a step of communicating at least one aircraft motorization and/or configuration control action to the pilot.

Advantageously the communicating of the main guidance command to the pilot is carried out by visualization on the primary flight display.

According to a variant the method according to the invention furthermore comprises the steps consisting in:

determining characteristic thresholds of exit from a loss of control on the basis of the characteristic thresholds indicative of loss of control

detecting an exit from the priority loss of control by comparing the reference data with characteristic thresholds of exit from the priority loss of control.

Advantageously the step of determining a characteristic threshold of exit takes into account a hysteresis and/or a confirmation time.

Advantageously, when an exit from the priority loss of control is detected, the guidance phase furthermore comprises post-exit holding steps consisting in:

determining post-exit guidance commands to place the aircraft in a stabilized holding situation

communicating the post-exit guidance commands to the crew via a flight director.

Advantageously the stabilized holding situation consists in levelling the aircraft wings at shallow climb as a function of the power of the engine available.

Advantageously the guidance commands are coupled to the flight controls manually through an action of the pilot or automatically.

Advantageously the aircraft motorization and/or configuration control actions are coupled to the motorization and/or configuration controls manually through an action of the pilot or automatically.

### BRIEF DESCRIPTION OF THE DRAWINGS

Other characteristics, aims and advantages of the present invention will become apparent on reading the detailed description which will follow and with regard to the appended drawings given by way of nonlimiting examples and in which:

FIG. 1 describes the steps of the method of diagnosis according to the invention,

FIG. 2 describes the sub-steps of the step of computing the reference data, according to a variant of the invention,

FIG. 3 illustrates a variation of the angle-of-incidence phase advance term,

FIG. 4 illustrates a mode of display of the type of priority loss of control,

FIG. 5 describes the steps of a guidance phase of the method according to the invention,

FIG. 6 illustrates a mode of display of the guidance commands on the flight director,

FIG. 7 illustrates a preferred mode of display of the main guidance command,

FIG. 8 describes the steps of the test of exit of loss of control and of the post-exit holding guidance,

FIG. 9 illustrates a device according to the invention,

FIG. 10 illustrates the architecture of a “recovery” function able to carry out the steps of the method according to the invention,

FIG. 11 describes a diagnosis and guidance module according to the invention.

### DETAILED DESCRIPTION

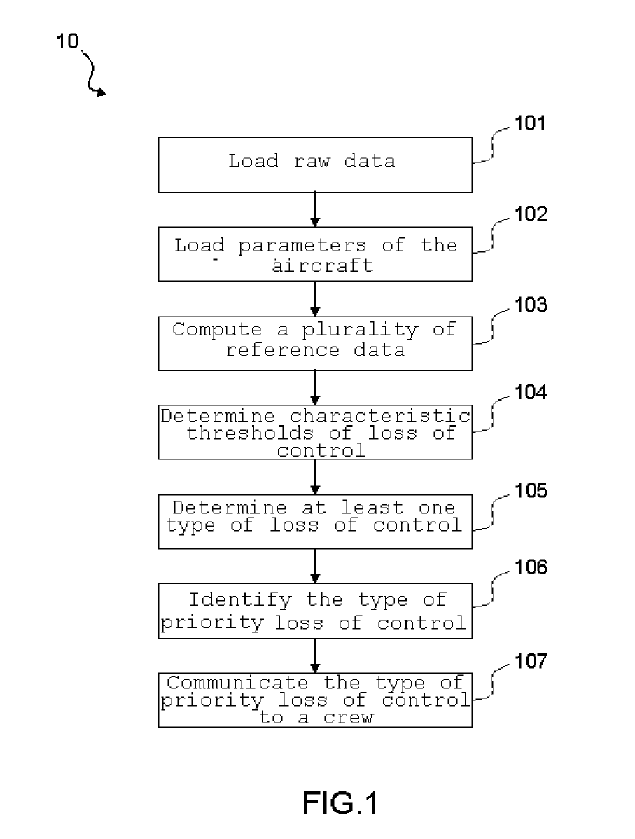

FIG. 1 shows the steps of the method 10 according to the invention for the diagnosis of a loss of control. The method is implemented by one or more onboard computers.

In a first step 101, the method loads raw data originating from onboard sensors.

The onboard sensors are inertial sensors and/or anemometric sensors and/or gyroscopic sensors. Stated otherwise they are sensors which measure a quantity directly, without needing a satellite communication. The method according to the invention is thus autonomous, more reliable and also more accurate. Indeed the data measured by direct sensors are more accurate than measurements carried out by satellite navigation sensor.

The raw data arising from these onboard sensors mainly comprise the attitude of the aircraft, composed of three angular quantities, the roll the pitch θ and the yaw ψ in relation to the three axes of the aircraft (the longitudinal axis, the transverse axis and the normal axis), the associated angular speeds and accelerations, the speeds of the aircraft in relation to the three axes, longitudinal, transverse and normal speed (also dubbed vertical speed) and the associated accelerations.

In a second step 102 the method loads parameters of the aircraft, consisting of parameters describing a state of the aircraft independently of its flight data, typically its attitude. These parameters comprise for example the parameters regarding the motorization of the aircraft arising for example from the engine computer, its mass, a state of the flaps, and optionally a state of the slats if the aircraft is equipped therewith, and a state of the landing gear.

In a step 103 the method computes a plurality of reference data relating to the aerodynamic behaviour of the aircraft, which serve as the basis for the establishment of the diagnosis of loss of control (LoC).

The reference data relate to the aerodynamic behaviour of the aircraft. These data comprise the angle of incidence α, the speed relative to the surrounding air, for example the CAS for “Calibrated Air Speed”, the load factor nz, the angle of roll, the angle of pitch θ, the yaw rate vψ and the vertical speed Vz (speed along the normal axis) of the aircraft.

For an aircraft of helicopter type, these data also comprise the speed of the rotor Vr.

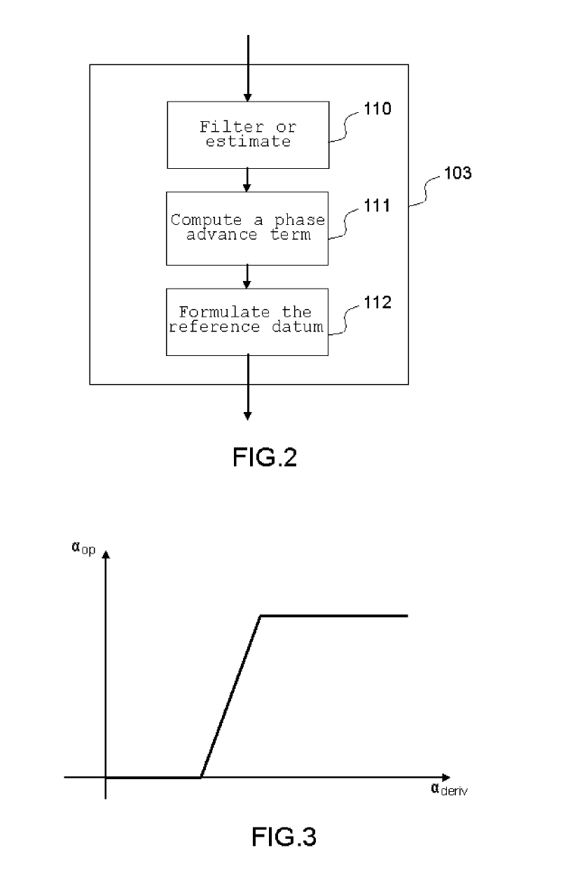

Step 103 computes a value for each of the reference data, on the basis of at least one value of a raw datum loaded in step 101. Step 103 comprises a preprocessing comprising, for at least one reference datum, a sub-step 111 of computing a phase advance term determined on the basis of the temporal evolution of the reference datum computed on the basis of at least one raw datum as illustrated in FIG. 2, the computation of each reference datum advantageously comprising a preprocessing comprising a sub-step 110 consisting in filtering raw data, or if appropriate estimating the reference datum on the basis of the raw data when the former is not measurable directly or is too noisy.

For at least one reference datum, the preprocessing comprises a sub-step 112 of formulating the reference datum in question, on the basis of the filtered raw datum or of the reference datum estimated in step 110 on the one hand and of the phase advance term computed in step 111 on the other hand.

This phase advance term makes it possible, when the aircraft exhibits a very dynamic behaviour in which it is liable to very rapidly cross a threshold relating to the reference datum, to anticipate this crossing so as to generate an alarm wittingly and to inhibit any false alarm of such a nature as to disturb the pilot's attention, while affording him the time needed for his action. A reference datum is thereafter formulated on the basis of the reference datum arising from the filtering/estimation step and from the phase advance term in a step 112.

The phase advance term Dap is evaluated on the basis of the derivative with respect to time of the reference datum. This derivative can be measured or estimated. The computation of this phase advance term Dap depends on the reference datum, and if appropriate, on raw data, other reference data, the parameters of the aircraft, and the operational use of this aircraft. The reference data having been computed with a preprocessing are also dubbed preprocessed reference data.

Thus, a preprocessed reference datum Dp can be defined as the sum of a reference datum Dfe arising from the filtering/estimation step to which is added a phase advance term Dap:

Dp=Dfe+Dap

In a first example, the following computation is performed for the angle of incidence preprocessed reference datum αₚ:

αₚ=α_{fe}+αₐₚ

α_{fe}=f(α_{loc})*1/(1+τρp)

with:
α_{loc} mean local angle of incidence measured by the angle of incidence probes, f transfer function between the local angle of incidence and the global angle of incidence of the aeroplane, dependent on the aerodynamic characteristics of the aeroplane,
p Laplacian differential operator.

The filtering of the output f(α_{loc}) is carried out with a first-order filter. αₐₚ is computed according to a curve such as described in FIG. 3 where α_{deriv} is computed as follows according to the conventional formulae of flight mechanics:

$${α}_{deriv} = \frac{32.17 * ( cos φ * cos θ ) - ( 1 + nz ) ) * 57.3}{T A S * 1.68} + q$$

with:
θ pitch (lateral trim), φ roll (longitudinal trim), nz load factor, TAS true air speed and q pitch rate.

The curve in FIG. 3 is an exemplary computation of phase advance term, which makes it possible to zero the phase advance term in the computation of αₚ when the evolution of the angle of incidence is slow, and to limit this term to reasonable values when the derivative of the angle of incidence is too considerable.

In a second example, the following computation is performed for the pitch preprocessed reference datum θp:

Θp=θfe+θap

θ_{fe}=θ*1/(1+τp)

θₐₚ=T*θ*p/(1+τp)

The following step 105 determines characteristic thresholds associated with each type of loss of control. The method according to the invention catalogues a set of type of loss of control, characterized by the evolution with respect to a threshold of at least one associated reference datum. The types of catalogued loss of control constitute for example a list of types of loss of control.

Thus, the characteristic thresholds indicative of loss of control are respectively associated with a set of parameters comprising at least one reference datum and one type of loss of control.

The characteristic thresholds are predetermined or dependent:

on the parameters of the aeroplane (for example a condition on the angle of incidence is dependent on the position of the flaps and slats if appropriate), and/or

on exterior data (for example the icing conditions), and/or

on the type of mission entrusted to the aircraft (for example if the aircraft performs a maritime patrol, a higher roll than for a civil transport mission is accepted).

Step 105 detects at least one type of loss of control by comparing the reference data with the characteristic thresholds determined in step 104. The method according to the invention also associates with each type of loss of control catalogued, a priority level as a function of the gravity of the effect of the loss of control on the aircraft.

As long as a loss of control is not detected, the method loops back to step 101.

Table I describes various types of loss of control (LoC) for an aircraft of aeroplane type, the reference datum (or data) associated with the type of loss of control for performing a diagnosis, and an example of conditions of realization of the loss of control, dubbed “conditions of SET” of the LoC in the form of crossing of thresholds of the associated reference datum (or data).

Of course the list of types of losses of control must be suited to the type of aircraft.

Table II describes additional situations of loss of control for an aircraft of helicopter type. Note that for a helicopter, the loss of control of “Spin” type does not exist.

TABLE I
example of types of loss of control, reference data, characteristic
thresholds and priority levels associated therewith.

| Type of loss of | Reference | | Pri- |
|---|---|---|---|
| control | datum | Condition of SET | ority |
| Stall | Angle of | αₚ > threshold or alarm | 1 |
| | incidence αₚ | emitted by a “stall | |
| | | warning” system | |
| Air speed too | Air speed | CASₚ > threshold or | 2 |
| high | CASₚ | Alarm of VMO/MMO | |
| “Overspeed” | | type | |
| Load factor too | Load factor | nzₚ > threshold | 3 |
| high | nzₚ | | |
| Spin | Angle of | αₚ > threshold and | 3 |
| | incidence αₚ | \|VΨₚ \| > threshold | |
| | Yaw rate VΨₚ | | |
| Turn engaged | Roll φₚ | φₚ < threshold and | 4 |
| “Spiral Dive” | Vertical | Vzₚ < threshold and | |
| | speed Vzₚ | αₚ < threshold | |
| | Angle of | | |
| | incidence αₚ | | |
| Pitch not too high | Pitch θₚ | \|θ_{p\|} < threshold and | 5 |
| and roll too high | Roll φₚ | \|φₚ \| > threshold | |
| “Overbank” | | | |
| Pitch too high | Pitch θₚ | θₚ > threshold | 5 |
| “Nose up” | | | |
| Pitch too low | Pitch θₚ | θₚ < threshold | 5 |
| “Nose down” | | | |

TABLE II
example of specific types of loss of control for
a helicopter, reference data, characteristic thresholds
and priority levels associated therewith.

| Type of loss of | Reference | | Pri- |
|---|---|---|---|
| control | datum | Condition of SET | ority |
| Rotor Speed too | Rotor speed | Vrₚ > threshold or alarm | 6 |
| high | Vrₚ | emitted by another system | |
| Rotor speed | Rotor Speed | Vrₚ < threshold or alarm | 6 |
| insufficient | Vrₚ | emitted by another system | |
| Enter Vortex | Vertical | Vzₚ < threshold and | 7 |
| | speed Vzₚ | CASₚ threshold and | |
| | | collective spacing position > | |
| | | threshold | |

The comparison between reference data and the characteristic thresholds is done by comparing the values with one another.

As a variant, prior to the detection step 105, the method according to the invention takes into account additional data originating from onboard computers which generate alarms, for example a system dubbed “Stall Warning”. These additional data are taken into account for the formulation of the diagnosis and processed as a supplement to the comparisons performed by the method in step 105.

During certain situations of loss of control several types of loss of control may be detected simultaneously. For example too high a pitch may be detected in the stall conditions, and a “spiral dive” may be detected with an “overbank”.

In this case, the method according to the invention identifies in a step 106 a type of priority loss of control, corresponding to the type of loss of control exhibiting the highest priority level among the detected types of losses of control.

When several losses of control have been determined simultaneously in step 105, the method therefore operates a sorting so as to identify the most problematic loss of control for the aircraft, dubbed priority loss of control, by means of the priority levels hereinabove.

When just one type of loss of control is determined in step 105, this single type of loss of control is dubbed type of priority loss of control.

In a following step 107 the method communicates the type of priority loss of control identified in step 106 to the crew, typically to the pilot. The communication to the pilot is typically performed through a sound message, for example “Recover, Recover . . . ” and/or a textual display comprising the activation of the “recovery” function and the identified type of priority loss of control.

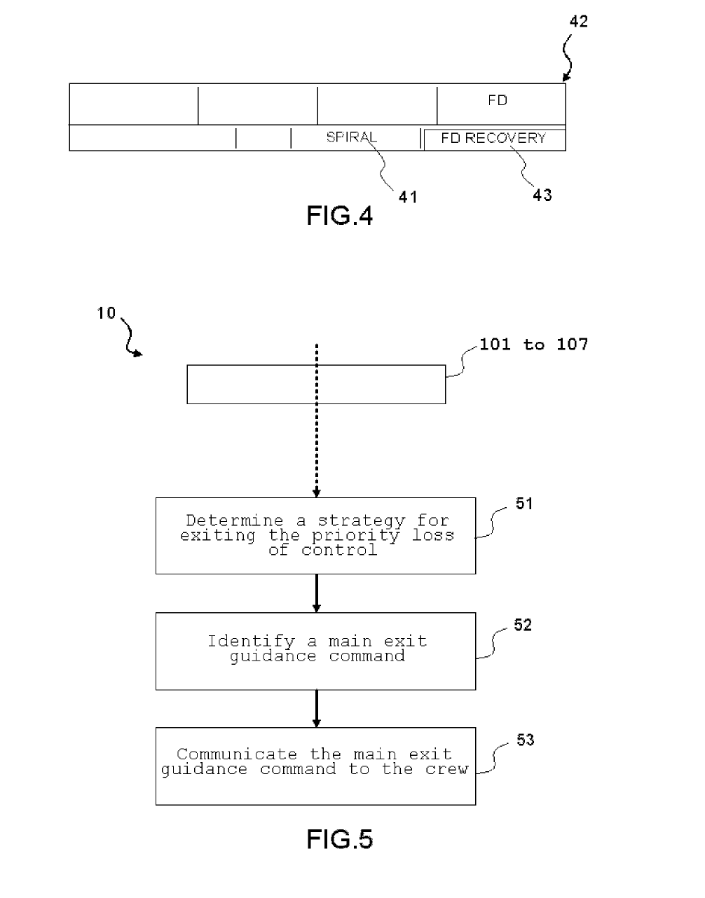

According to a preferred mode illustrated in FIG. 4, the display of the type of priority loss of control 41 is carried out on the display banner 42 of the modes of the automatic pilot (FMA for Flight Mode Annunciator). A display 43 “FD Recovery” also indicates to the pilot that the method according to the invention has detected a loss of control situation. The conventional information featuring on this banner will previously have been deleted so as not to disturb the pilot.

An advantage of using this specific banner is of rendering the information immediately visible by the pilot on an interface to which he is accustomed. Another advantage is of replacing an existing guidance mode with an emergency guidance mode.

The advantage of identifying the type of priority loss of control and of communicating it to the pilot is that of highlighting the most dangerous type of loss of control in terms of gravity for the aircraft, and thus of increasing the relevance of the diagnosis.

According to one embodiment, the method 10 furthermore comprises a guidance phase to make it possible to exit from the loss of control, illustrated in FIG. 5. Exiting from a loss of control situation is dubbed “Recovery”.

A first step 51 determines a strategy for exiting from the priority loss of control identified in step 106.

A strategy arises from a library of “recovery” strategies, associated with an LoC and with the aeroplane parameters.

The strategy for exiting from the priority loss of control comprises a list of exit guidance commands to be executed on controls of the aircraft. “Guidance commands” is understood to mean the commands intended to modify the attitude of the aircraft, these modifications being able thereafter to be carried out manually by the pilot or with a certain level of automation.

The “recovery” guidance commands are established on the basis of the exit strategy corresponding to the identified type of loss of control and suited to the type of aircraft. The guidance commands are computed for the three axes of the aircraft: pitch, roll and yaw.

A following step 52 identifies a main exit guidance command to be executed by priority on an axis of the aircraft.

The main guidance command is the command to be executed first before any other manoeuvre.

This main guidance command corresponds to a degraded mode of piloting intended to rapidly and effectively exit from the loss of control, in a way that is not necessarily optimal in terms of comfort for the passengers for example.

The guidance can be effected on the 3 axes in simultaneity, but to be as effective as possible, a main guidance axis is favoured, which has to be effected as first action.

For example for the loss of control of “turn engaged” type cited in table I, the “Recovery” strategy imposes by priority an exclusive action on the roll with levelling of the wings followed by an action on the pitch.

Step 53 communicates the main exit guidance command to the crew.

The advantage of extracting a main guidance command and communicating it to the crew consists of an improvement in the effectiveness of exit on account of the provision of clear and non-ambiguous information to the pilot that allows him to react rapidly, without hesitation or error in a situation of considerable stress.

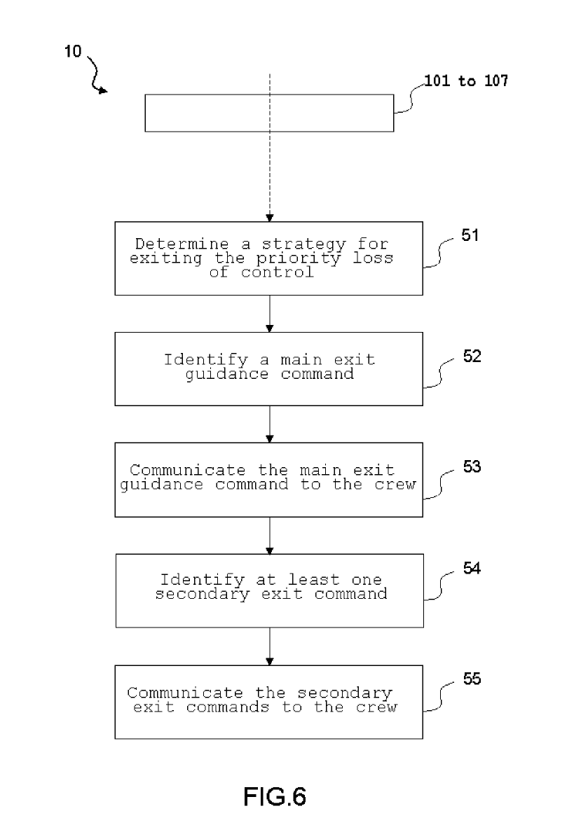

According to one embodiment illustrated in FIG. 6, the exit strategy comprises a main exit guidance command regarding a favoured axis and at least one secondary exit command comprising a guidance secondary command and/or at least one action for controlling the motorization and/or a configuration of the flaps, and slats if appropriate. These actions are associated with the guidance commands, supplement them if appropriate, and depend on the type of aircraft. The secondary commands in combination with the main command make it possible to implement a more effective and safer exit strategy.

The method according to the invention thus comprises a step 54 of identifying at least one secondary command and a step 55 of communicating these secondary commands to the crew.

For certain loss of control situations, the combination of a guidance secondary command and of an action for controlling the motorization and/or a flap configuration allows an exit from the loss of control situation which is optimal.

Indeed, the communication to the pilot of a set of control actions for the engine, for the slats and for the flaps in association with the actual guidance commands makes it possible to improve the pilot guidance function by rendering it consistent with the procedures determined in the flight manuals and taught to the pilot. It also makes it possible to remind the pilot of what to do in a situation of stress.

Examples of strategy are given hereinbelow:

“Nose up” situation i.e. a high pitch:

main guidance command: action on the Roll

guidance secondary command: Reduce the pitch (drop the nose)

engine control action secondary command: reduce motorization

“Stall” situation:

main guidance command: Drop the nose on Pitch

engine control action secondary command:
increase motorization
extend a flap notch
   “Dive” situation i.e. turn engaged:

main guidance command: level wings on Roll

engine secondary command: reduce motorization

guidance secondary command: increase the pitch (lift the nose)

“Overspeed” situation i.e. excessive speed:

main guidance command: increase the pitch (lift the nose)

secondary command: reduce motorization

The exit strategy and the associated commands are dependent on the type of aircraft. For example for the loss of control through stalling of the aircraft: as a function of the type of aircraft, jet with engine under the wings, or turboprop with the engines on the wings, the action “REDUCE THRUST” or “INCREASE THRUST” will not be identical since they generate “nose up” or “nose down” motions on the aircraft.

According to a preferred variant for an aircraft equipped with a flight director implementing a conventional piloting aid, the method according to the invention communicates a set of guidance commands to the crew via the flight director. The pilot is thus assisted to exit from the loss of control in a manner that is familiar to him and therefore well mastered.

Generally the “recovery” strategy determined by the method according to the invention may be simpler and less efficacious than the guidance algorithms implemented in modern automatic pilots, but makes it possible to exit rapidly from loss of control situations, this being the objective of the method according to the invention.

According to a preferred variant, the visualization of the main guidance command is carried out on the primary flight display (PFD).

The display is very visible and supplements if appropriate the exit guidance performed via the flight director through a conventional symbology of a bar or chevrons on the PFD.

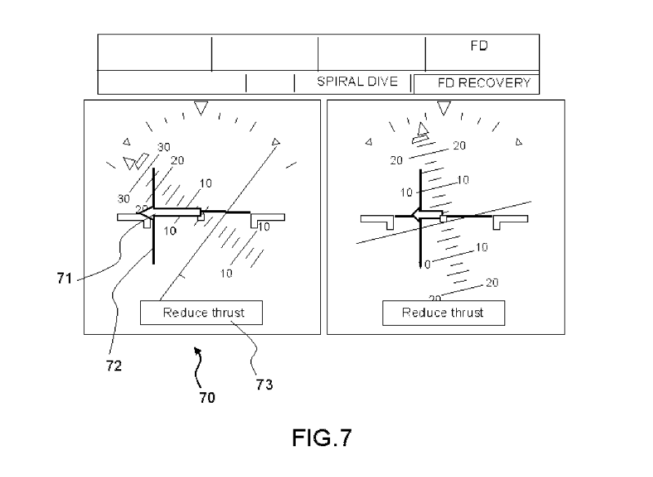

According to a preferred embodiment illustrated in FIG. 7, the display of the main guidance command is carried out by an arrow 71 indicating the direction in which the pilot must manoeuvre his controls so as to recover healthy attitudes. The arrow 71 is superimposed on the commands given by the flight director in the form of bars 72 in the primary flight display (PFD) 70.

As a variant, the display of the main guidance command is carried out by a symbology of speed vector type on which a speed vector command is given to the pilot. The pilot modifies the speed vector of the aircraft so as to follow the guidance command, by acting on his controls.

As a variant also illustrated in FIG. 7 control actions 73 on the engine (and/or an aeroplane configuration of slats and/or flaps) are displayed by textual messages in the primary display 70.

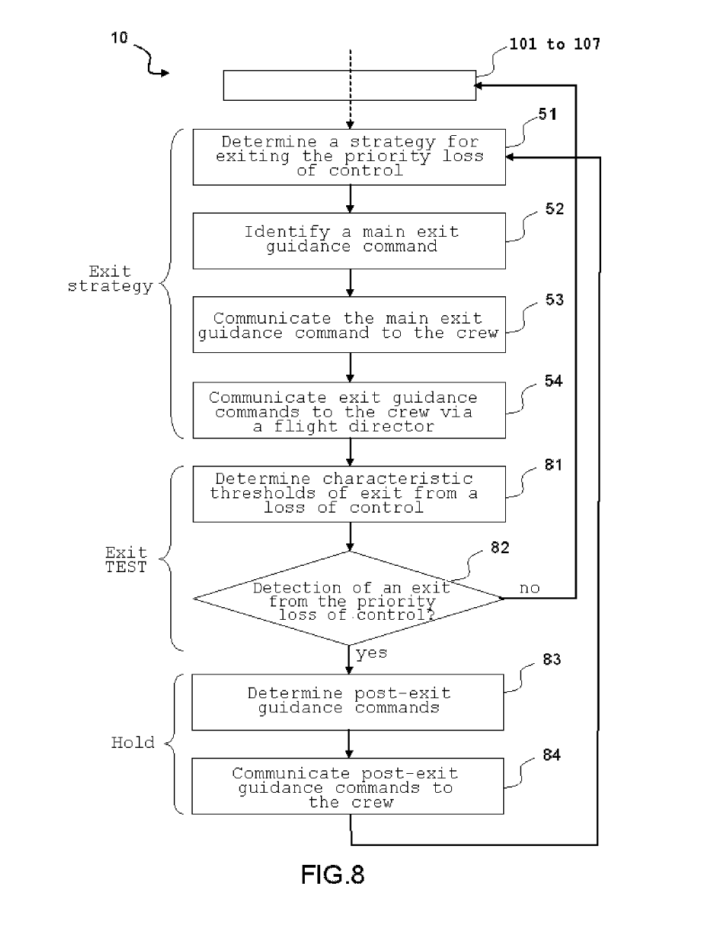

According to a preferred variant illustrated in FIG. 8 the guidance phase of the method according to the invention comprises a test aimed at establishing whether the aircraft has or has not exited the situation of priority loss of control for which the guidance is implemented.

The method of diagnosis and guidance according to the invention comprises a step 81 consisting in determining characteristic thresholds of exit from a loss of control on the basis of the thresholds characteristic of loss of control.

As a function of the type of loss of control, a characteristic threshold of exit is dependent on the associated type of loss of control and on the reference datum to which it applies.

The computation of these thresholds takes place according to the same logic as that of the entry thresholds in the loss of control situation that were computed in step 104.

Furthermore, an exit threshold may be:

predetermined (equal or not to the entry threshold)

computed on the basis of the corresponding entry threshold by taking into account a hysteresis and/or a confirmation time, (see examples in table III for an aircraft of aeroplane type).

For certain types of loss of control, the reference datum (or data) making it possible to diagnose entry to a loss of control situation is not identical to the datum making it possible to determine an exit from the situation in question.

A hysteresis or a confirmation time regarding the exit conditions is used to make it possible to remain in the loss-of-control guidance mode for a sufficient time making it possible to guarantee exit from this loss of control. Stealthy guidance commands are thus also avoided, when the aircraft is flying very close to the threshold values of SET.

In particular, the characteristic thresholds of exit are computed for the identified type of priority loss of control.

The test 82 consists in detecting an exit from the priority loss of control by comparing the reference datum or data associated with the identified priority loss of control with the characteristic thresholds of exit therefrom.

The conditions relating to exit from the loss of control are dubbed “conditions of RESET”.

TABLE III
example of types of loss of control, reference data
and characteristic thresholds of exit as a function
of the thresholds characteristic of entry

| Type of loss of control | Reference datum | Condition of RESET |
|---|---|---|
| Stall | Angle of incidence | αₚ < threshold − |
| | αₚ | hysteresis for more |
| | | than t1 s |
| Air speed too high | Air speed CASₚ | CASₚ < threshold − |
| “Overspeed” | | hysteresis for more |
| | | than t2 s |
| Load factor too high | Load factor nzₚ | nzₚ < threshold − |
| | | hysteresis for more |
| | | than t3 s |
| Spin | Angle of incidence αₚ | αₚ < threshold − |
| | Yaw rate VΨₚ | hysteresis and |
| | | \|VΨₚ \| < threshold |
| Turn engaged | Roll ₚ | ₚ < threshold − |
| “Spiral Dive” | Roll rate V | hysteresis and |
| | | \|V \| < threshold |
| Pitch not too high and | Roll ₚ | \| ₚ\| < threshold − |
| roll too high | Roll rate V | hysteresis and |
| “Overbank” | | \|V \| < threshold |
| | | for more than t6 s |
| Pitch too high | Pitch θₚ | θₚ < threshold − |
| “Nose up” | | hysteresis |
| Pitch too low | Pitch θₚ | θₚ > threshold + |
| “Nose down” | | hysteresis |

If the conditions of RESET are not satisfied, the method loops back to step 101 so as to verify that the loss of control diagnosis is ever correct and to continue to generate and to display appropriate guidance commands.

If the conditions of RESET are satisfied, the aircraft has exited from the priority loss of control.

According to a preferred variant also illustrated in FIG. 8 the guidance phase of the method according to the invention comprises, in addition to a “recovery” guidance described previously, a post-exit cruising holding guidance or post recovery.

The post-exit holding guidance comprises a first step 83 consisting in determining post-exit guidance commands to place the aircraft in a stabilized holding situation.

The following step 84 communicates post-exit guidance commands to the crew via a flight director. Here the guidance takes place according to a conventional mode with the flight directors.

According to one embodiment the stabilized holding situation is identical for all the “recovery” exits. According to a preferred variant, for an aircraft of aeroplane type, it consists in levelling the aircraft wings at shallow climb as a function of the power of the engine available.

As a variant, the guidance function is coupled to an automatic piloting system to extricate the aircraft automatically from the loss of control situation.

Thus the guidance commands are coupled to the flight controls (or directly to the control surfaces through the actuators) automatically, it being possible for the coupling to be effected manually through a pilot action or automatically.

Likewise the aircraft motorization and/or configuration control actions are coupled to the aircraft motorization and/or configuration controls automatically, it being possible for the coupling to be effected manually through a pilot action or automatically.

In the case of manual coupling, it is the pilot who chooses to couple the guidance to the automatic pilot, doing so at any moment on the basis of the identification and communication of the priority loss of control, for example by pressing the customary button for engaging the automatic pilot.

In the case of the automatic coupling, the guidance is coupled to the automatic pilot right from detection and identification of the priority loss of control. As a variant this coupling is performed on the basis of criteria such as a time delay dependent on the mission performed by the aircraft.

On account of the poor awareness of the aerodynamic models outside of the normal flight domain, or else of lack of authority of the automatic pilot, coupling to the automatic pilot may be prohibited if the aircraft is in too extreme a zone of the flight domain, in particular if the attitudes in terms of longitudinal trim or roll are too considerable.

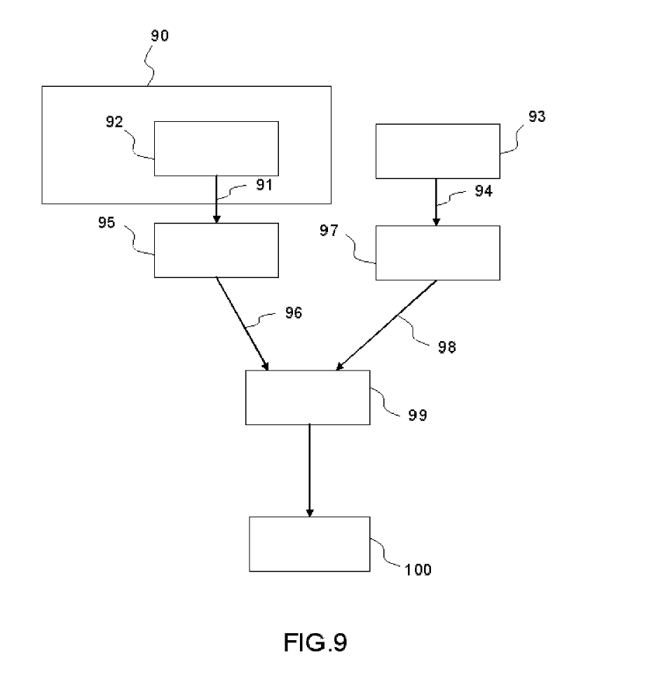

According to another aspect of the invention, the invention relates to a device for diagnosis of a loss of control of an aircraft illustrated in FIG. 9 comprising:

a module (90) for generating raw data (91) originating from onboard sensors (92),

a module (93) for loading the parameters (94) of the aircraft, for example an engine computer,

a module (95) for computing a plurality of reference data (96) relating to the aerodynamic behaviour of the aircraft comprising a preprocessing module comprising for at least one reference datum a sub-module for computing a phase advance term determined on the basis of the temporal evolution of the said reference datum,

a module (97) for determining the characteristic thresholds (98) of loss of control respectively associated with a set of parameters comprising at least one reference datum and one type of loss of control,

a module (99) for detecting at least one type of loss of control by comparing the reference data with characteristic thresholds, each type of loss of control having an associated priority level, the said module making it possible to identify the type of priority loss of control corresponding to the type of loss of control exhibiting the highest priority level,

a module (100) for communicating the type of priority loss of control to the crew.

Furthermore, the device can comprise a guidance module comprising:

a module for determining a strategy for exiting from the priority loss of control comprising a list of exit guidance commands to be executed on controls of the aircraft, the module making it possible to identify a main exit guidance command to be executed by priority on an axis of the aircraft,

a module for communicating the main exit guidance command to the crew.

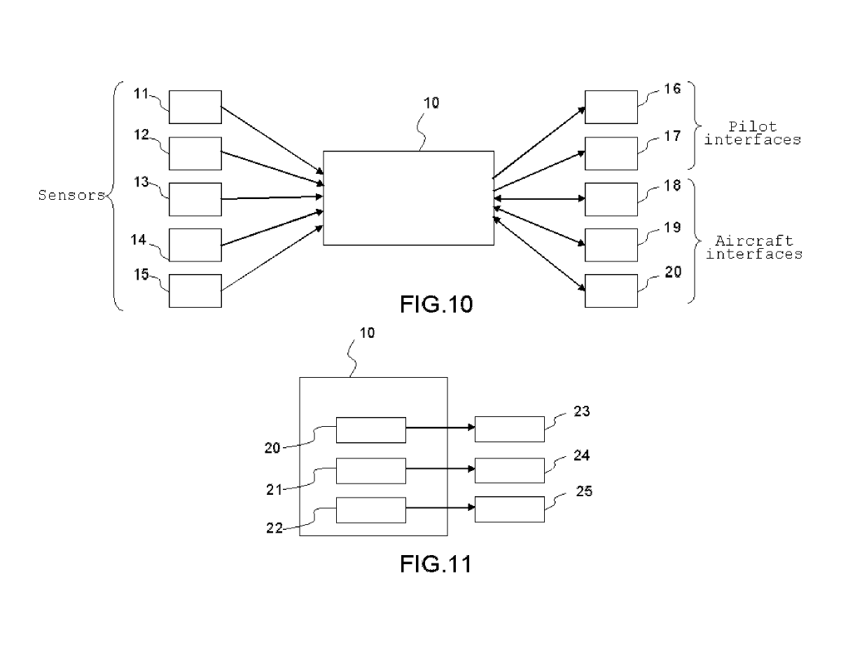

FIG. 10 illustrates the architecture of a “recovery” function that is able to carry out the steps of the method according to the invention.

The diagnosis and guidance module 10 receives data from anemometric sensors 11, inertial sensors 12, satellite navigation sensors 13, the engine computer 14 of the aircraft, as well as information 15 regarding other aeroplane parameters.

The module 10 can be hosted in various types of avionics computers, for example computers dedicated to the piloting/guidance of the flight or computers for managing alarms.

The module 10 interacts with the pilot via displays 16 and alerting systems 17, and with the equipment of the aircraft comprising the flight controls 18, the throttle or the engine computer 19 as well as with other systems 20 acting on the control surfaces, for example a “Stall protection” system.

The diagnosis and guidance module 10 may thus comprise three sub-functions such as illustrated in FIG. 11. A diagnosis sub-function 20, displaying the type of loss of control 23 identified, a guidance sub-function 21 displaying the guidance commands 24 for exiting from the loss of control situation, and a sub-function 22 for coupling to the automatic pilot making it possible to control electric flight controls or actuators 25.

According to another aspect of the invention, the invention relates to a computer program product comprising code instructions making it possible to perform the steps of the method according to the invention.

1. A method for diagnosis of a loss of control of an aircraft comprising the steps:
loading raw data originating from onboard sensors,
loading parameters of the aircraft,
computing a plurality of reference data relating to the aerodynamic behaviour of the aircraft, each reference datum being obtained on the basis of at least one value of a loaded raw datum, the computation step comprising a preprocessing, the said preprocessing comprising for at least one reference datum a sub-step of computing a phase advance term determined on the basis of the temporal evolution of the said reference datum,
determining characteristic thresholds indicative of loss of control respectively associated with a set of parameters comprising at least one reference datum and one type of loss of control,
detecting at least one type of loss of control by comparing the reference data with characteristic thresholds, each type of loss of control having an associated priority level, and
when at least one type of loss of control is detected:
identifying the type of priority loss of control corresponding to the type of loss of control exhibiting the highest priority level,
communicating the type of priority loss of control to a crew.

2. The method according to claim 1, wherein the reference data comprise an angle of incidence, a speed relative to the surrounding air, a load factor, an angle of roll and an angle of pitch, a yaw rate and a vertical speed of the aircraft.

3. The method according to claim 1, wherein the preprocessing comprises:
a sub-step consisting in, for each reference datum, filtering at least one raw datum or estimating the reference datum on the basis of at least one raw datum, and
a sub-step consisting in, for at least one reference datum, formulating the said reference datum on the basis of the reference datum computed in the filtering/estimation step on the one hand and of the phase advance term on the other hand.

4. The method according to claim 1, wherein at least one characteristic threshold is determined on the basis of parameters of the aircraft and/or of exterior data and/or of the type of mission performed by the aircraft.

5. The method according to claim 1, further comprising a step of loading additional data originating from onboard computers which generate alarms prior to the step of detecting at least one type of loss of control.

6. The method according to claim 1, wherein the communicating of the type of priority loss of control to the pilot is carried out on the display banner of the modes of the automatic pilot.

7. The method according to claim 1, further comprising a guidance phase to make it possible to exit from the loss of control comprising the steps consisting in:
determining a strategy for exiting from the priority loss of control comprising a list of exit guidance commands to be executed on controls of the aircraft,
identifying a main exit guidance command to be executed by priority on an axis of the aircraft, and
communicating the main exit guidance command to the crew.

8. The method according to claim 7, further comprising a step of identifying at least one secondary exit command.

9. The method according to claim 8, further comprising a step of communicating the secondary exit commands to the pilot.

10. The method according to claim 7, wherein the communicating of a set of exit commands is performed via a flight director.

11. The method according to claim 7, wherein the communicating of the main guidance command to the pilot is carried out by visualization on the primary flight display.

12. The method according to claim 7, further comprising the steps:
determining characteristic thresholds of exit from a loss of control on the basis of the characteristic thresholds indicative of loss of control, and
detecting an exit from the priority loss of control by comparing the reference data with characteristic thresholds of exit from the priority loss of control.

13. The method according to claim 12, wherein the step of determining a characteristic threshold of exit takes into account a hysteresis and/or a confirmation time.

14. The method according to claim 12, wherein, when an exit from the priority loss of control is detected, the guidance phase further comprises post-exit holding steps:
determining post-exit guidance commands to place the aircraft in a stabilized holding situation,
communicating the post-exit guidance commands to the crew via a flight director.

15. The method according to claim 14, wherein the stabilized holding situation consists in levelling the aircraft wings at shallow climb as a function of the power of the engine available.

16. The method according to claim 7, wherein the guidance commands are coupled to flight controls manually through an action of the pilot or automatically.

17. The method according to claim 9, wherein aircraft motorization and/or configuration control actions are coupled to motorization and/or configuration controls manually through an action of the pilot or automatically.

18. A device for diagnosis of a loss of control of an aircraft, the device comprising modules for implementing the steps of the method according to claim 1.

19. The device for diagnosis of a loss of control of an aircraft, the device comprising modules for implementing the steps of the method according to claim 1, and for guiding the aircraft so as to exit from the loss of control, further comprising modules for implementing said method wherein the communicating of the type of priority loss of control to the pilot is carried out on the display banner of the modes of the automatic pilot.

20. A computer program product, the said computer program comprising code instructions making it possible to perform the steps of the method according to claim 1.
